(19) United States
(12) Patent Application Publication
(10) Pub. No.: US 2014/0305346 A1
(43) Pub. Date: Oct. 16, 2014

(54) Alkaline Earth Oxides For Green Processes For metals and other Material

(71) Applicant: Indra Neelameggham, (US)

(72) Inventors: Ramaswami Neelameggham, South Jordan, UT (US); Robert E. Brown, Prattville, AL (US)

(73) Assignee: Indra Neelameggham, South Jordan, UT (US)

(21) Appl. No.: 13/862,623

(22) Filed: Apr. 15, 2013

(51) Int. Cl. C01F 11/08; C22C 24/00; C22B 26/22; C25C 1/02; C01F 5/12; C22B 26/20

(52) U.S. Cl. CPC C01F 11/08; C01F 5/12; C22B 26/20; C22B 26/22; C25C 1/02; C22C 24/00
USPC 106/765; 423/638; 423/155; 106/739; 75/392; 205/560; 205/557

(57) ABSTRACT

The present invention teaches the method to use the sulfate or sulfites based raw materials, such as magnesium, calcium and other alkative earth sulfates or sulfites to produce the respective oxides in a carbon five basis, by using sulfur as the fuel and the reductant. The invention also utilizes renewable energy such as solar thermal or green electricity wherever possible. This approach provides a green process, of ultra-low carbon dioxide emission, for the production of magnesium, other alkaline earth metals and other material which requires alkaline earth oxide, such as in the production of carbon free Portland cement requiring lime. The invention also provides a useful outlet for waste streams leading to sustainable processes. The cost of the production of these precursors are kept low by concurrently producing a saleable by-product—sulfuric-acid.

### BACKGROUND OF THE INVENTION

The climate control community requires a low carbon foot-print which is accomplished by minimizing and avoiding carbon dioxide emissions in the production of materials. One of the important end product material used in minimizing overall life cycle CO₂ emissions in the automotive industry is the use of light metals such as magnesium. Magnesium, the lightest structural metal has been developed and used in the automotive structural components to help lighten the mass of automobiles, and thereby help provide better gas mileage. Better gas mileage means lower carbon dioxide emissions.

But, in a life cycle analysis (LCA), the carbon dioxide emissions in the production of the light metal is taken into the equation when comparing the use of a light metal with the conventional steel components or an alternative aluminum component. The present production methods for magnesium are either electrolytic or the silico thermal reduction of magnesium compounds. It has been noted that the carbon dioxide emissions in the western electrolytic process is as low as 6.9 kg CO₂ per kg magnesium, while the Pidgeon silicothermal production as high as 37 kg/kg magnesium.

The present invention teaches the method to use the sulfate based raw materials, such as magnesium and calcium sulfates to produce the respective oxides in a carbon free basis, by using sulfur as the fuel and the reductant. The invention also utilizes renewable energy such as solar thermal or green electricity wherever possible. This approach provides a green process, of ultra-low carbon dioxide emission, for the production of magnesium, other alkaline earth metals [beryllium, calcium, strontium and barium] and other material which requires alkaline earth oxide, such as in the production of carbon free Portland cement requiring lime.

### PRIOR ART

Production of Magnesium with Inherent Carbon Dioxide Emissions:

The Pidgeon process for producing magnesium as practiced in China during the 1990s had high coal consumption of about 11 kg/kg magnesium [32.3 kg CO₂/kg Mg from a coal with 80% fixed carbon] and the starting raw material dolomite which contains 2 moles of CO₂ per mole of magnesium [or 3.6 kg CO₂/kg magnesium] showed emissions of 35.9 kg CO₂/kg Mg, with another 1.1 kg CO₂/kg from rest of the process making to the 37 kg CO₂/kg Mg. The recent publications of Chinese Pidgeon process with waste heat utilization indicates lowered coal consumption to about 5 kg/kg Mg [14.7 kg CO₂/kg Mg]; this gives total emissions of about 19.4 kg CO₂/kg Mg.

An atmospheric pressure silicothermic process using dolomite [CaCO₃.MgCO₃] as raw material reduced by ferro-silicon, FeSi, called the Gossan—Zuliani process claims that it can reduce the carbon dioxide emissions to 9.1 kg CO₂/kg magnesium.

The western electrolytic production process—such as from the Great Salt Lake brines, produces an energy efficient brine containing 8.5% magnesium and 4.2% sulfate [T.Tripp] which is 29 percent MgCl₂ and 5.3% MgSO₄ and minor quantities of sodium, potassium and other chlorides. The energy efficiency of the process to this step comes from the benefit of using renewable solar energy in the production of 8.5% magnesium brine by converting 0.4% magnesium brine in the Great Salt Lake. But even with the use of solar thermal process of evaporative crystallization, the carbon dioxide emissions are to be reckoned with, as the process raw material after solar evaporation is an aqueous solution containing impurities. It is stated that the electrolytic process downstream cannot tolerate the sulfate in the cell feed and therefore requires calcium chloride to convert the MgSO₄ to MgCl₂; the calcium chloride for this is produced from using calcium carbonate and hydrochloric acid produced in the process as noted in the reference above. This would result in a close to 32 to 33.0% magnesium chloride solution which has to be evaporated in a spray drier, making a dry magnesium chloride powder containing magnesium oxide and water [of hydration]. This powder is further purified by chlorination with petroleum coke—carbon. The evaporation of water in the purified brine using natural gas as a fuel will result in carbon dioxide emissions, as well as from the carbo-chlorination of the magnesium chloride powder. These on the minimum, can result in carbon dioxide emissions reported in literature of the 6.9 kg CO₂/kg Magnesium if hydroelectric power is used for the electrolysis. The total CO₂ emissions will be higher if the electrolytic power is from fossil carbonaceous fuels. Other magnesium chloride based electrolysis processes have similar carbon di-oxide utilization, from having to evaporate the water from magnesium chloride in a conventional fashion with carbonaceous fuels.

During the past decade a newer electrolytic magnesium process is being developed called the Metal oxide separation technology using magnesium oxide as a raw material. It has been estimated that the CO₂ emissions from this would be 4.9 kg CO₂/kg CO₂. Most of this is probably from magnesite raw material which is typically calcined using carbonaceous fuel. The contribution from the rest of the process in the above value is unknown, as the production levels are still less than 1 kg per day in the equipment built to date as a pilot plant to show the actual life of the oxide ion selective membrane which will define the overall life cycle carbon dioxide emissions from the process.

### Prior Art in the Conversion of the Sulfate Minerals:

Prior art in the industrial conversion of the sulfate minerals in making the magnesium oxide and or calcium oxide is very minimal. The conversion process, a few in number, utilized carbonaceous fuels in the decomposition reaction, as shown in the patent literature. In reference literature, laboratory studies on the thermodynamics of decomposition of magnesium sulfate, and the comparison of different reductants such as carbon monoxide, hydrogen or sulfur, has been reported.

Hans Zirngibl and Robert Griessbach described a process which made sulfur and magnesia from kieserite in their patent U.S. Pat. No. 2,171,966. This was accomplished in a single stage or two stage process using hydrogen or hydrogen rich gas such as water gas from coal and steam by reducing pellets of kieserite—catalyst iron oxide and magnesium chloride binder. Pure hydrogen mentioned as a reductant in this process—which in most cases were made from carbonaceous fuels by reforming reaction and only rarely from electrolysis of water using carbonless hydro-power. The patent notes that when water gas is used instead of pure hydrogen, carbon dioxide is also produced.

Gunter Gloss describes a process of making magnesium oxide and water soluble potassium sulfate from ores containing potassium sulfate and magnesium sulfate using carbonaceous fuels such as coal and natural gas. [U.S. Pat. No. 2,776,191].

Partridge and Frass described a process for converting K2SO4 in the polyhalite to K₂S by use of carbonaceous fuels—carbon monoxide and water vapor or natural gas and water vapor, which produced a water soluble potassium compound and water insoluble mix of magnesium and calcium. [U.S. Pat. No. 1,975,798].

Robert Griessbach, et al described a process for converting kieserite to magnesia and SO₂ in a rotary calciner where kieserite and coal are fed at the top of the inclined reactor with natural gas with a small quantity of air being fed near the discharging magnesia at the bottom of the reactor at 1000° C. Rest of the combustion air is introduced near the center of the kiln at 900° C., and the off gases containing sulfur dioxide, water vapor and carbon dioxide exited near the feed top end at 700° C. [U.S. Pat. No. 2,230,592].

H. E. Cross, et al of Metallgesellschaft Aktiengesselschaft disclosed the conversion of magnesium containing carbonate ores with sulfuric acid to magnesium sulfate followed by making pure magnesium oxide in 1978, and recycle the sulfuric acid [U.S. Pat. No. 4,096,235] with inherent carbon dioxide release in the starting step. The magnesium sulfate decomposition step shows the simultaneous use of conventional fuels and sulfur shown as a reductant.

In a similar vein, there are only a few patented descriptions of making calcium oxide [lime] from calcium sulfate ores. Burwell described a process where gypsum, CaSO4.2H2O was converted to lime and hydrogen sulfide using a hydrocarbon gas such as natural gas and steam with the exclusion of oxygen near 1000° C. [U.S. Pat. No. 2,740,691]

Prentiss Viles discussed the production of lime and hydrogen sulfide using cobalt molybdate catalyst and a combination of natural gas and steam at 1400° F. [U.S. Pat. No. 2,970,893] from calcium sulfate.

Foecking and Austin described the recovery of sulfur and lime from gypsum reaction with the use of carbonaceous fuel in a two stage process—the first stage reactants being gypsum and hydrogen sulfide producing sulfur dioxide and water vapor along with calcium sulfide solids which are reacted in the second stage with a carbonaceous, fuel and steam to produce lime solids and hydrogen sulfide gas for recycle reaction in stage one along with carbon dioxide. [U.S. Pat. No. 3,607,036].

Silvio J. Spigolon Sr. and Eddie K. Wilson describe a process to recover sulfur values and siliceous lime. Here the dry phospho-gypsum, from the phosphoric acid plant is heated to 1200°-1250° C. under reducing conditions with coal to produce SO₂ gas and siliceous lime. The SO₂ is then passed through a lime or limestone scrubber to eliminate any remaining fluorine values, dried and utilized in a contact sulfuric acid plant. [U.S. Pat. No. 4,734,272].

A method of making elemental sulfur and lime is discussed by Mark Paisley using carbonaceous fuels such as wood gas, natural gas, etc. [U.S. Pat. No. 6,024,932].

### PRESENT INVENTION

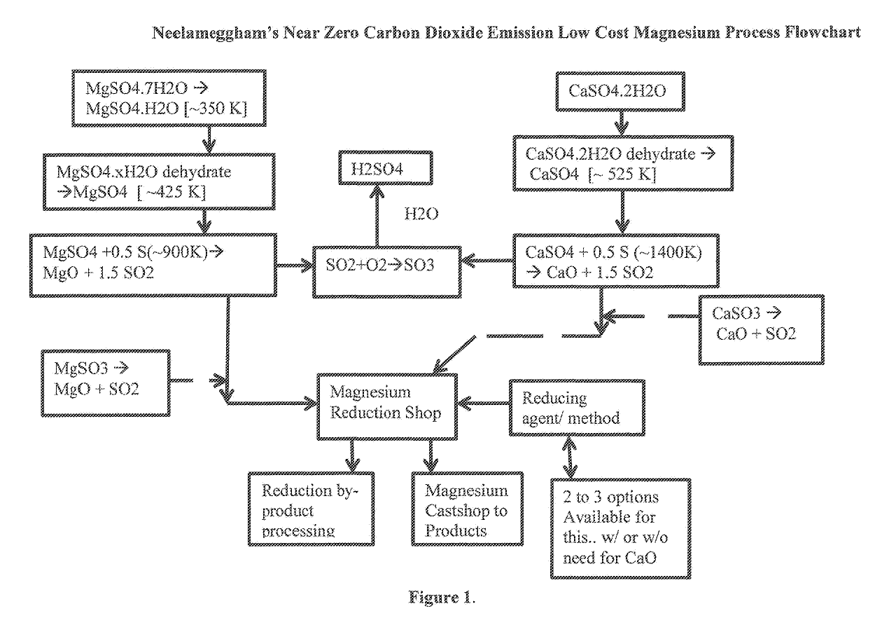

FIG. 1 is a simple block, flow diagram showing how magnesium production can be kept as a green process by judicial application of green alkaline earth oxides—magnesia and lime produced from readily available sulfate or sulfite raw material which are decomposed to form green magnesium oxide and green calcium oxide along with simultaneous production of marketable sulfuric acid in maintaining, process costs low. Such a green process will have a total emission of carbon dioxide in the 0 to 2.5 kg carbon dioxide per kg of magnesium

The present invention intends to use the naturally occurring low cost magnesium and calcium raw materials which have been unexploited during the past century in making the magnesium metal. The use of this material can be made with near zero carbonaceous fuel requirements. Such a process will bring the carbon dioxide emissions in magnesium metal production to a very low value of less than 2 kg carbon dioxide per kg magnesium metal. In this invention, the naturally occurring raw material is intended to be processed into magnesium oxide alone with or without calcium oxide which can be applied to any one of the conventional downstream extractive metallurgical techniques of western electrolytic method, the silico thermic process, the recently developed metal oxide separation technology, or the announced atmospheric pressure processes.

The invention shows that conversion of magnesium sulfate and calcium sulfate raw materials to prepare the magnesium oxide and calcium oxide can be done without the need for any carbonaceous or other green-house gas emitting fuels. Magnesium sulfate occurs naturally in Evaporite minerals in the form of epsomite or Epsom salt [MgSO₄.7H₂O], Kieserite [MgSO₄.H₂O] or as other double sulfates such as langbeinite [K₂SO₄.2MgSO₄], leonite, schoenite, loweite, astrakanite, vanthoffite, bloedite [Na₂SO₄.MgSO₄.4H₂O] and several other mixed salts containing MgSO₄. Calcium sulfate occurs naturally as gypsum [CaSO₄.2H₂O], anhydrite [CaSO₄], and as a double salt—syngenite [K₂SO₄.CaSO₄.H₂O]. There are natural deposits of polyhalite [2K₂SO₄.MgSO₄.CaSO₄.2H₂O]. In addition, these minerals can be produced from saline lakes or solar salt plant bitterns worldwide by effective solar energy application of pond processes. The double salt CaSO₄.3 MgSO4 is also known since the early 1970s and this can be beneficially used following decomposition to the oxides, with, known alumino thermic thermal reduction process.

In addition to the above sulfate raw material, considerable quantities of sulfites of magnesium and or calcium [MgSO₃ and CaSO₃] are produced either separately or mixed and collected as waste material in the flue gas desulfurization of coal as fuel. Considerable quantities of gypsum from waste building material are available which can be used in the production of carbon free calcium oxide or substituted in the production of carbon free Portland cement.

### EXAMPLE 1

The primary step involves the removal of waters of hydration from the mineral which may be needed when the raw material such as Epsom salt contains 7 moles of water per mole of magnesium sulfate. The thermodynamic enthalpy properties indicate that 425.7 kcal per mole of magnesium would be required to convert 6 moles of these hydration water to making kieserite containing one mole of water per mole of magnesium sulfate. This conversion can be accommodated below 110° C. by means of solar thermal drying. It is further possible to convert this kieserite to anhydrous magnesium sulfate by further heating to about 250° C.—which is also possible by solar thermal drying. The drying can be aided by the addition of dark coloring to the material being dried. The conversion of kieserite to anhydrous magnesium sulfate will consume another 76.8 kcal/mol of magnesium. To put this in perspective, if the drying were done using carbonaceous fuel such as natural gas, instead of solar thermal method, the industry would be emitting a theoretical minimum of 4.02 tons of CO₂/per ton of magnesium for converting epsomite to kieserite, and another 0.72 tons of CO₂ per ton of magnesium. In the real world, one has to allow for process inefficiencies including heat losses which would require fuel equivalent emission of another 0.5 to 1.0 tons of CO₂ per ton of magnesium. The solar thermal drying would thus avoid 4.5 to about 5.5 tons of CO₂ per ton of magnesium.

It is to be understood that naturally formed sulfates or the sulfates from evaporites or fertilizer production may have to be treated by washing and recrystallization steps in getting the sulfate precursors for the decomposition reaction making the alkaline earth oxides.

### EXAMPLE 2

The solar thermal dried kieserite and or anhydrous magnesium sulfate is then converted to magnesium oxide and sulfur oxides by the following reaction:

MgSO₄.H₂O═MgSO₄+H₂O - - - +76.8 kcal/mole Mg [A]

MgSO₄═MgO+SO₂+0.5 O₂ - - - +77.5 kcal/mole Mg [B]

These two reactions are endothermic requiring added heat. It was noted earlier that the first reaction easily occurs at below 250° C. and is amenable for simple solar dehydration, whereas the second reaction requires temperatures of above 925° C. The solar dehydration is either performed in open ponds or in a solar thermal drier sized for the production rates. The endothermic heat can be supplied by co-burning sulfur with oxygen as shown by the exothermic reaction [C] which compensates the endothermic heat required

S+O₂═SO₂ - - - −74.8 kcal/mole [C]

These reactions also are more energy efficient by using enriched or pure oxygen than air to minimize excess energy needs.

In practice, additional exothermic heat from sulfur burning may be needed to offset the heat losses and material makeup losses. This is accomplished burning some additional sulfur and making more market grade sulfuric acid and or sulfur dioxide. The grade of sulfur is selected to fit process conditions.

### EXAMPLE 3

Thermodynamic computations show that the reaction temperature is lowered to 725° C. by carrying out the following reactions, with lower endothermic heats of reactions

MgSO₄.H₂O+0.5 S═MgO+H₂O+1.5 SO₂ - - - +68.4 kcal/mole [D]

MgSO4+0.5 S═MgO+1.5 SO2 - - - 50.9 kcal/mole [E]

This gives two options of carrying out the reaction
[a] the process is carried out in high temperature solar thermal; reactors with specially designed receivers. Or,
[b] using a reactor where sulfur-oxygen co-burning per reaction [C]—providing the reaction heat. Both the reactors are provided with equipment to handle the off gas sulfur dioxide in producing either compressed sulfur dioxide for sale or sent to sulfuric acid plant.

It is to be noted that the reaction temperatures are further lowered to about 550° C. by using vacuum assistance in the reactor making solar thermal reactor operation more favorable.

### EXAMPLE 4

The green magnesia formed in the above examples is utilized in conventional electrolytic processes as shown in this and the next example.

When the magnesium production is by electrolysis of magnesium chloride—the green magnesia is further processed by the sulfo-chlorination of magnesium oxide by the following reaction to produce the anhydrous magnesium chloride needed as a feed for electrolysis.

MgO+0.5 S+Cl₂═MgCl₂+SO₂ [F]

This would have near zero CO₂ emissions, compared to the chlorination reaction practiced in the twentieth century using carbon from coke, etc.

MgO+0.5 C+Cl₂═MgCl₂+0.5 CO₂ [G]

This reaction would cause an additional 0.91 kg CO₂/kg Mg on a minimum, or about 1 kg CO₂/kg Mg in practical cases in making an anhydrous magnesium chloride electrolytic feed.

### EXAMPLE 5

The magnesium oxide thus produced from the sulfates is pure and can be used in electrolysis such as Metal Oxide Separation Technology eliminating most of the known carbon dioxide emissions of about 3.5 to 4 kg CO₂/kg magnesium attributable to conventional sea water magnesia or calcined magnesia.

### EXAMPLE 6

Gypsum, CaSO₄.2H₂O, is easily dehydrated to anhydrite, CaSO₄, at low temperatures. The decomposition of anhydrite to calcium oxide requires higher temperature, about 500° C. higher than that of magnesium sulfate to magnesium oxides. Higher temperature is required to overcome the stable intermediate compound calcium sulfide during the decomposition. The endothermic heat for this can be supplied by co-burning sulfur and oxygen—per this invention, unlike earlier approaches which utilized carbonaceous fuels; and provide clean decomposition products of calcium oxide, and sulfur dioxide.

The sulfur dioxide off-gas is combined with oxygen in making sulfuric acid product stream, while the calcium oxide stream is utilized by mixing with magnesium oxide for thermal reduction processes.

### EXAMPLE 7

The naturally occurring double salts in solar evaporites—including bittern ponds are treated by initial dehydration step as needed at low temperatures, followed by high temperature decomposition along with sulfur and sufficient oxygen for heat balancing the endothermic reactions with exothermic sulfur oxidation. This is a two-step process. The first step is preferably carried out at low temperature using hybrid fluid bed drier which is a combination of solar and wind-powered electrical heating. The second step is carried out in a fluid bed reactor. The product stream is a mixture of water soluble sulfate, and the alkaline earth oxide and sulfur dioxide gas. 294 gm of dehydrated schoenite [K2SO4.MgSO4] is mixed with 48 gm sulfur and 32 gm oxygen and reacted at 1000 K producing 40 gm magnesium oxide, 174 gm water soluble potassium sulfate and 80 gm of sulfur dioxide in the off gas.

It is preferable to separate the fertilizer grade sulfate of potash from schoenite and recrystallizing magnesium sulfate from the mother liquor and process it to green magnesia instead of the thermal decomposition of schoenite as noted in the previous sentence.

### EXAMPLE 8

Waste magnesium sulfite from a coal flue gas desulfurizing process is dehydrated by using low temperature solar thermal rotary drier. Then the dehydrated magnesium sulfite is moved to a higher temperature hybrid rotary reactor which can utilize a combination of solar thermal energy as well as co-burnt sulfur with oxygen carrying out a controlled decomposition producing the green magnesia for further use such as magnesium metal production.

### EXAMPLE 9

Evaporite magnesium sulfate is mixed with proper proportion of calcium sulfate and decomposed by sulfo thermal heating in making the combined magnesium and calcium oxide suitable for Pidgeon process magnesium reduction. In this example, when the reactor is operated with a vacuum, formation of combined MgO and CaO occurs at about 1070° C., thus reducing the amount of co-burnt sulfur and oxygen.

### EXAMPLE 10

Natural gypsum or waste gypsum is mixed with clay—where the calcium content of the gypsum equated the conventional calcium content from limestone and burnt to make a clinker where the process heat is supplied by sulfur and oxygen in a special kiln. This produced the clinker equivalent of Portland cement. The off gas from the kiln is then taken to sulfuric acid production. In another variation of this example, waste calcium sulfite from a flue gas desulfurization plant is substituted for limestone equivalent calcium supply to the Portland cement production. This is not to be confused with the conventional gypsum added Portland cement initially made from limestone.

We claim:

1. The production of alkaline earth oxides—such as beryllium oxide, magnesium oxide, calcium oxide, strontium oxide or barium oxide—in a ‘green’ fashion, i.e. without any carbon dioxide emissions, by utilizing alkaline earth sulfate or alkaline earth sulfite raw material—along with sulfur as the main reductant and as the main fuel; and the further use of such alkaline earth oxide in making other materials including metals or alloys of alkaline earth oxides, in a low carbon dioxide emission ‘green’ process.

2. The production of magnesium oxide [magnesia], an alkaline earth oxide noted in claim 1, without any carbon dioxide emissions, by utilizing magnesium sulfate or magnesium sulfite raw material along with sulfur as the main reductant and as the main fuel; and the use of such magnesia wherever magnesia is used in a low carbon dioxide emission—green process.

3. The production of calcium oxide [calcia or lime], one of the alkaline earth oxides noted in claim 1, without any carbon dioxide emissions, by utilizing calcium sulfate or calcium sulfite raw material along with sulfur as the main reductant and as the main fuel; and the use of such calcia or lime wherever lime is used in a low carbon dioxide emission—green process.

4. The endothermic heat for reactions per claim 2 is provided by carbon dioxide—free heating methods such as solar heat, green electricity heat or by co-burning sulfur and oxygen in the reactors—to maintain essentially a carbon dioxide free process, including application of vacuum assistance to further lower decomposition temperature.

5. The endothermic heat for reactions per claim 3 is provided by carbon dioxide—free heating methods such as solar heat, green electricity heat or by co-burning sulfur and oxygen in the reactors—to maintain essentially a carbon dioxide free process, including application of vacuum assistance to further lower decomposition temperature.

6. The magnesium sulfate containing raw material used in the process per claim 2 includes any of the naturally occurring as well as low cost solar evaporite salts from bitterns or solar ponds or from potash processes or as a byproduct in a chemical process containing magnesium sulfates such as epsomite [MgSO4.7H2O], hexahydrite [MgSO4.6H2O], kieserite [MgSO4.H2O], from double sulfates containing magnesium, such as calcium—magnesium double sulfate [CaSO₄.3MgSO₄], langbeinite [K₂SO₄.2MgSO₄] , leonite, schoenite, loweite, astrakanite, vanthoffite, bloedite [Na₂SO₄.MgSO₄.4H₂O], and from triple sulfate such as polyhalite [[2K₂SO₄.MgSO₄.CaSO₄.2H₂O], and all other mixed salts containing magnesium sulfates.

7. The calcium sulfate containing raw material used in the process per claim 3, includes any of the naturally occurring as well as a low cost solar evaporite salts from bitterns or solar ponds or from potash processes or as a byproduct in a chemical process, or a waste product gypsum containing calcium sulfates such as gypsum [CaSO₄.2H₂O], plaster of Paris or hemihydrate [CaSO₄.0.5H₂O], anhydrite [CaSO₄], from double sulfate such as syngenite [CaSO₄.K₂SO₄.H₂O], CaSO₄.3MgSO₄ and from triple sulfate such as polyhalite [2K₂SO₄.MgSO₄.CaSO₄.2H₂O], and other mixed salts containing calcium sulfates.

8. The magnesium sulfite containing raw material used in the process per claim 2 includes sulfur oxide scrubbing by-product magnesium sulfite.

9. The calcium sulfite containing raw material used in the process per claim 3 includes sulfur oxide scrubbing by-product calcium sulfite.

10. When the process per claim 2 is carried out using a double or triple sulfate salt, the process is further carried out to separate the water soluble sulfates of alkali metals such as K₂SO₄ or Na₂SO₄, and producing green magnesia.

11. When the process per claim 3 is carried out using a double or triple sulfate salt, the process is further carried out to separate the water soluble sulfates of alkali metals such as K₂SO₄ or Na₂SO₄, and producing green lime.

12. The production of green [carbon dioxide emission free] magnesia per claim 2 specifically applied to making magnesium metal by electrolysis or by thermal reduction methods; including conversion to magnesium chloride from green magnesia by sulfo chlorination to maintain further green processing or by carbo chlorination which introduces a fractional carbon dioxide footprint compared to conventional processes carried out using carbonaceous fuel in making the magnesia precursor.

13. The production of green [carbon dioxide emission free] lime per claim 3 specifically applied to making magnesium metal by electrolysis or by thermal reduction method such as Pidgeon process requiring both magnesium and calcium oxides.

14. Production of green alkaline earth oxides such as beryllium oxide, magnesium oxide, calcium oxide, strontium oxide or barium oxide, per claim 1 and conversion of individual or combined oxides by a secondary reduction such as metallothermal or electrolysis into metals or alloys of (the alkaline earth element) beryllium, magnesium, calcium, strontium or barium.

15. The production of green magnesia and lime carried out in a combined fashion, per claim 1, from using a combination in any proportion as needed from a starting double sulfate of magnesium and calcium, or by a physical mixture of sulfate or sulfite of magnesium and calcium; such a mixed green magnesia and lime suitable for further producing green magnesium metal.

16. The production of green [carbon dioxide emission free] lime per claim 3 as applied to making cement such as Portland cement in a green fashion. This includes clinker making with clay along with calcium sulfate or sulfite raw materials in a furnace or kiln with most or all endothermic heat supplied by sulfur and oxygen; such a process will co-produce green Portland cement of different grades and sulfur oxide products. The process will include making Portland cement clinkers with low cost clay and waste gypsum or scrubber effluent calcium sulfite.

17. The beneficial use of carbon trading credit by use of green alkaline earth oxide generated per claim 1 in any applicable product.
